(19) United States
(12) Patent Application Publication
(10) Pub. No.: US 2005/0047983 A1
(43) Pub. Date: Mar. 3, 2005

(54) Ester quaternary cationic flotation collectors

(76) Inventors: Tim B. Cameron, Mulberry, FL (US); J. Douglas Van Orsdale, Bartow, FL (US); D. Todd Parker, Tampa, FL (US)

Correspondence Address: DENNISON, SCHULTZ, DOUGHERTY & MACDONALD, 1727 KING STREET, SUITE 105, ALEXANDRIA, VA, 22314, US

(21) Appl. No.: 10/651,620

(22) Filed: Aug. 29, 2003

(51) Int. Cl. C01B 33/00

(52) U.S. Cl. 423/324

(57) ABSTRACT

A new class of useful reagents for ore beneficiation are obtained by the quarternization of the reaction products of tertiary alkanolamine derivatives and fatty acids or their ester derivatives. The reagents are particularly useful for the flotation separation of ore values from siliceous materials.

### BACKGROUND OF THE INVENTION

1. Field of the Invention

The present invention relates to novel quaternary ammonium reagents derived from alkanolamine condensates of fatty acids or fatty ester derivatives, and their use in an improved process for phosphate beneficiation.

2. Discussion of the Background

In the present commercial beneficiation of siliceous phosphate ores, a deslimed and sized phosphate ore is conditioned with and then floated by a fatty acid collector and fuel oil reagent in an aerated aqueous solution at a pH of typically around 9.0. This flotation process yields a low-grade phosphate concentrate containing from about 50 to 65 weight percent bone phosphate of lime (BPL). The low-grade concentrate from the aforementioned flotation is blunged with acid to remove fatty acid collector and the phosphate is further concentrated by flotation of residual silica from the concentrate using a so-called cationic amine collector. Other mineral ores containing siliceous material, such as iron ore, are also beneficiated by flotation.

Froth flotation processes are generally taught in the following U.S. patents: U.S. Pat. No. 4,234,414; U.S. Pat. No. 4,238,409; U.S. Pat. No. 4,276,156; U.S. Pat. No. 4,287,052; U.S. Pat. No. 4,364,824; U.S. Pat. No. 4,523,991; U.S. Pat. No. 4,737,273; and U.S. Pat. No. 4,883,586.

A large number of cationic compounds have been used as cationic collectors for the removal of siliceous material from phosphate ores by flotation. Historically, they involve the use of neutralized tallow amines or more commonly bisamidoamines derived from fatty acid condensates of diethylenetriamine (DETA).

More recently, owing primarily to the ever-increasing expense of these amines, a shift to fatty condensates based upon distillation residues, e.g., the higher polyethylenepolyamines has taken place. Examples of such amines are triethylenetetramine (TETA), tetraethylenepentamine (TEPA), pentaethylenehexamine (PEHA), or mixtures of even higher polyethylenepolyamines.

Even more recently, the availability of these distillation residues has declined precipitously and prices have increased accordingly. This is primarily due to, for example, industry consolidations, production cutbacks, improved distillation fractionation, increased demand in other end uses and manufacturing shifts away from the so-called EDC route to that based upon reductive amination utilizing monoethanolamine (MEA) as a starting material.

The latter process appears far more environmentally friendly, though is far less capable of producing higher polyethylenepolyamines. What is now needed is a more economical and stable supply of an amine suitable for conversion to a collector for silica flotation. Additionally, the collector should possess equal or better selectivity than those now employed commercially.

### SUMMARY OF THE INVENTION

It is an object of the present invention to provide a cationic flotation reagent that avoids the disadvantages of the prior art.

It is another object of the invention to provide a cationic flotation collector or reagent, which is low in cost but which is equally or more effective than the prior art collectors.

It is another object of the invention to provide a cationic flotation reagent that is based on readily available starting materials to assure long-term supply.

It is another object of the invention to provide a cationic flotation collector or reagent that is more readily biodegradable than those of the prior art.

A more complete appreciation of the invention and many of the attendant advantages thereof will be readily obtained, as the same becomes better understood by reference to the following detailed description.

### DETAILED DESCRIPTION OF THE INVENTION

To achieve these and other objects, the invention is directed towards the use of a collector for the froth flotation of siliceous matter, wherein the collector system comprises use of an effective amount of a compound represented by the formula: 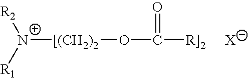
wherein
R is C₁₂-C₂₂ alkyl or alkenyl or mixtures thereof;
R₁ is C₁-C₄ alkyl or hydroxyethyl substituent;
R₂ is methyl or ethyl substituent; and
X⁻ is a cationic compatible anion.

Some specific examples of quaternary esteramines that appear suitable for preparation of flotation reagents include:
(1) Methyl bis[ethyl (tallate)]-2-hydroxyethyl ammonium methyl sulfate
(2) Methyl bis[ethyl (tallowate)]-2-hydroxyethyl ammonium methyl sulfate
(3) Dimethyl bis[ethyl (tallate)]ammonium methyl sulfate
(4) Dimethyl bis[ethyl (tallowate)]ammonium methyl sulfate
(5) Methyl bis[ethyl (soyate)]-2-hydroxyethyl ammonium methyl sulfate
(6) Dimethyl bis[ethyl (soyate)]ammonium methyl sulfate

The present invention relates primarily to novel quaternary amines (often referred to as “quats”) derived from the condensation products of fatty acids and triethanolamine (TEA) or N-methyldiethanolamine (MDEA) and their use as reagents for silica flotation.

The quaternized esters shown by the formula above are conveniently prepared in a two-step process. Two examples are given below using dimethylsulfate as a quaternizing agent. In these cases X⁻ is CH₃OSO₃⁻

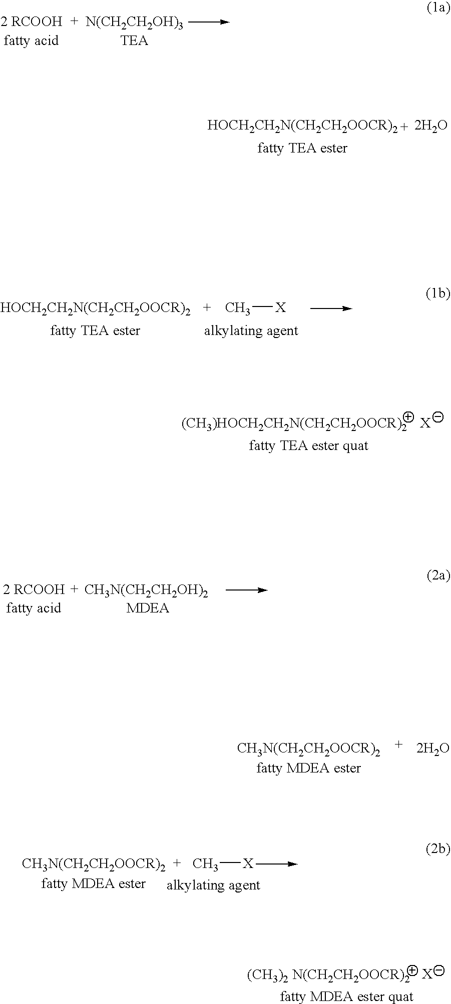

Examples of suitable fatty acids or their ester derivatives that may be employed are those derived from shorter chain coconut oil to longer chain tall oil, tallow or other vegetable based sources, that is, oils rich in C12 to C18 fatty acids, and above. Unsaturation of the fatty acids or ester derivatives appears to have a beneficial effect on the process, particularly with regard to final formulation viscosity.

The following patent documents, which are incorporated herein by reference thereto, disclose quaternary esteramines and their preparation: U.S. Pat. No. 3,915,867; U.S. Pat. No. 4,767,547; U.S. Pat. No. 5,296,622; and EP Patent No. 02 840 36.

Examples of alkanolamines possessing utility are the previously mentioned triethanolamine (TEA) and N-methyldiethanolamine (MDEA). Also, of utility are higher alkyl N-ethyl, N-propyl or N-butyldiethanolamines. Further, in the manufacture of MDEA a co-product, CH₃N(CH₂CH₂OH)(CH₂CH₂OCH₂CH₂OH), is also produced. Quaternary amines based upon alkanolamines possessing this co-product are operative and can be quite cost effective.

Alkylating agents conventionally used for quaternization are acceptable. These include primarily among others: methyl chloride, dimethyl sulfate, diethyl sulfate or potentially trimethyl phosphate. For TEA ester condensates, dimethyl sulfate is particularly advantageous.

While ratios of fatty acid or equivalent derivative to TEA or MDEA or related derivatives of about 2.5:1 to 1.2:1 are operable, preferably, ratios closer to 1.9 to 2.1:1 are more ideal. With regard to the quaternization, better results are obtained by using close to a stoichiometric amount of the quarternizing agent based upon the total of mono and disubstituted TEA ester produced as tertiary TEA esters react with difficulty. When MDEA is employed, this is less a problem as is the use of less active quarternizing or alkylating agents.

The manufacture of these products is easily carried out by heating the fatty acid or a suitable derivative in the stoichiometric amounts mentioned above in the presence of TEA or MDEA. Reaction conditions are such as to utilize ideally better than 95% of the fatty derivative in a manner that maximizes the yield of the difatty-TEA or MDEA adduct.

When fatty acids are employed, esterification may be carried out at a temperature of from about 150° to about 220° C. An optimal reaction velocity is reached if the reaction is carried out at a temperature in the range of from about 180° to about 200° C. Preferably the reaction is continued until the reaction product has an acid value below about 5. Titanium or tin based alkoxide catalysts, among others, are suitable, but are not necessary.

When esters of fatty acid are used, transesterification with alkanolamines may be carried out at lower temperatures of from about 80° to about 220° C., and preferably from about 80° to about 150° C. in the presence of from about 0.05% to about 0.5% by weight of basic catalyst, for example sodium methylate. If desired, the alcohol formed during the reaction may be removed before quarternization of the esters.

Quaternization is most easily carried out by addition of sufficient alkylating agent to the aminoester, again at temperatures, typically from about 70° to about 90° C. or more, sufficient to essentially complete the reaction without leaving unreacted alkylating agent in the product. Typically, the amount of alkylating agent used is from about 0.7 to about 1.0 mol alkylating agent per mol of aminoester. Further, use of diluents is often advantageous to overcome potential viscosity problems during the alkylation. Isopropanol or propyleneglycol are common. Many patents cover the manufacture of similar ester quaternary amines as they are now being used extensively in fabric softener compositions, e.g., see U.S. Pat. No. 3,915,867, owing to their excellent performance, good biodegradability and relatively low toxicity.

For flotation the quarternized esteramines can preferably be diluted after completion of the alkylation reaction and then cooled to storage temperatures, normally not exceeding 55° C. The amount(s) and type(s) of diluent will depend upon the nature of the fatty derivative employed and final product performance desired. Among the preferred diluents are the relatively low molecular weight alcohols and alcohol or glycol derivatives or other by-products that are well known in the industry to act as viscosity and/or froth modifiers. Typically, an acceptable cationic flotation based upon these novel quaternary aminoester may contain from 40 to 80% active material. Amine flotation reagents are typically diluted to about 3 to 10% for flotation evaluation. For this class of flotation reagent, formulation pHs are preferably from about 5 to about 5.5.

Below are two formulations based upon commercially available TEA quaternary amines, frother and dilution water. These are followed by performance tests demonstrating the utility of these quaternary amines in phosphate flotation.

| Additive | Formulation (%) | Formulation (%) |
|---|---|---|
| Stepan Agent 2694-75¹ | 5.0 | 4.5 |
| Frother² | — | 0.5 |
| Water | 95.0 | 95.0 |

¹90% active dioleic TEA quaternary amine.
²butyl alcohol bottoms stream.

### EXAMPLES

Having generally described this invention, a further understanding can be obtained by reference to certain specific examples that are provided herein for purposes of illustration only and are not intended to be limiting unless otherwise specified.

As examples of their ability to act as silica flotation agents several flotation experiments were carried out using phosphate cleaner feed from the Cargill South Ft. Mead mine. Analyses were % BPL=62.84, % Insol=15.91. As a control, a cationic reagent prepared from a fatty acid condensate of pentaethylenehexylamine (PEHA), neutralized with acetic acid and containing the same frother was used. The % neutralized standard cationic amine and frother were identical in activity to Formulation II. Again, it was applied at 5% in water.

In the actual float work, 600 gram charges (wet basis, about 500 grams dry) were charged into the standard Denver laboratory float cell, filled with water and stirring begun. Thereafter, the amine solution was added and after an additional ten seconds, air was introduced to allow flotation to take place. After about one minute, flotation ceased and the concentrate and tailings fractions collected and analyzed in the usual fashion. Results from this work are shown in Tables I and II.

From Table I, comparing the standard and formulation I, we find the ester quaternary amine without frother at equal dosages to give concentrate insols higher than the standard, meaning that it does not possess the ability at the given dosages to float as much sand.

TABLE I

| | | CONCENTRATE | | | TAIL | | | | |
|---|---|---|---|---|---|---|---|---|---|
| | Dose | | | Wt. | | | Wt. | Total | Percent |
| Sample | #/ton | % BPL | % Insol | (gram) | % BPL | % Insol | (gram) | Weight(g) | Recovery |
| Std. | 0.20 | 67.49 | 8.47 | 443.9 | 3.48 | 95.97 | 40.1 | 484.00 | 99.54 |
| | 0.40 | 71.22 | 3.94 | 415.5 | 6.77 | 90.63 | 70.9 | 486.40 | 98.40 |
| Formulation I | 0.20 | 66.59 | 10.70 | 463.2 | 2.54 | 96.10 | 24.5 | 487.70 | 99.80 |
| | 0.40 | 69.73 | 5.87 | 438.7 | 3.84 | 94.27 | 52.2 | 490.90 | 99.35 |

BPL = bone phosphate of lime
Insol = insolubles

In Table II, however, with frother (Formulation II) the ester quaternary amine demonstrates improved strength. Further, at the higher dose (0.4 lb/ton) the trend towards still lower concentrate insol with higher recovery compared to the typical industry standard augers well for this class of amine. Further, formulation II possessed less quaternary amine actives than formulation I, illustrating the effect of incorporating frother in the formulation.

TABLE II

| | | CONCENTRATE | | | TAIL | | | | |
|---|---|---|---|---|---|---|---|---|---|
| | Dose | | | Wt. | | | Wt. | Total | Percent |
| Sample | #/ton | % BPL | % Insol | (gram) | % BPL | % Insol | (gram) | Weight(g) | Recovery |
| Std. | 0.20 | 67.49 | 8.47 | 443.9 | 3.48 | 95.97 | 40.1 | 484.00 | 99.54 |
| | 0.40 | 71.22 | 3.94 | 415.5 | 6.77 | 90.63 | 70.9 | 486.40 | 98.40 |
| Formulation II | 0.20 | 67.01 | 9.39 | 455.6 | 3.18 | 95.21 | 36.3 | 491.90 | 99.62 |
| | 0.40 | 70.98 | 3.71 | 421.3 | 5.27 | 92.51 | 65.0 | 486.30 | 98.87 |

As a follow up project, the same TEA based quaternary amine was compared to a similar version based upon MDEA (see equations 2a and 2b). In the work Stepan Agent 2694-80, a 90% active version in propylene glycol was used. Both were initially formulated by adding the same frother directly to the ester quaternary amine concentrate in ratios of 10:1.8. Solutions were subsequently diluted to 5% as before and similarly floated and analyzed. Feed used in the effort was again provided by Cargill from their South Ft. Mead mine, although from a different date. Feed BPL was 48.92% and insols ran 34.31%. Data for these floats are provided in Table III.

TABLE III

| | | |
|---|---|---|
| CONCENTRATE | TAIL | Total |

| Sample | | Amine | % | | Wt. | | | Wt. | Weight | Percent |
|---|---|---|---|---|---|---|---|---|---|---|
| Name | Run | lb/ton | BPL | % Insol | (gram) | % BPL | % Insol | (gram) | (g) | Recovery |
| TEA ester | 1 | 0.20 | 62.05 | 21.19 | 385.1 | 3.04 | 96.08 | 88.2 | 473.30 | 98.89 |
| quat | | | | | | | | | | |
| | 2 | 0.30 | 71.25 | 9.99 | 335.3 | 3.78 | 96.74 | 140.8 | 476.10 | 97.82 |
| | 3 | 0.40 | 73.25 | 6.31 | 323.1 | 4.42 | 94.16 | 154.7 | 477.80 | 97.19 |
| | 4 | 0.50 | 73.02 | 5.42 | 314.9 | 4.73 | 93.78 | 158.7 | 473.60 | 96.84 |
| | 5 | 0.60 | 74.78 | 4.58 | 310.7 | 5.66 | 92.61 | 166.1 | 476.80 | 96.11 |
| | 6 | 0.70 | 75.42 | 3.79 | 301.0 | 7.26 | 91.48 | 170.3 | 471.30 | 94.84 |
| MDEA ester | 7 | 0.20 | 65.67 | 16.78 | 361.6 | 3.47 | 95.26 | 111.9 | 473.50 | 98.39 |
| quat | | | | | | | | | | |
| | 8 | 0.30 | 72.24 | 8.61 | 328.7 | 4.56 | 93.96 | 136.0 | 464.70 | 97.45 |
| | 9 | 0.40 | 74.53 | 5.65 | 314.5 | 5.79 | 91.95 | 165.0 | 479.50 | 96.08 |
| | 10 | 0.50 | 75.59 | 4.28 | 305.4 | 7.34 | 89.11 | 174.0 | 479.40 | 94.76 |
| | 11 | 0.60 | 74.95 | 4.10 | 296.9 | 7.77 | 88.00 | 179.8 | 476.70 | 94.09 |
| | 12 | 0.70 | 75.06 | 3.66 | 297.5 | 8.66 | 86.07 | 185.7 | 483.20 | 93.28 |

Comparing results shows the MDEA based quaternary amine with the given formulations to be slightly stronger, i.e., leaving less insol in the concentrate at equal dosages. As for selectivity, examining recoveries at nearly equal insol, shows the MDEA based ester quaternary amine to be slightly less selective (see runs 4 and 9). Here, the TEA version yielded an insol of 5.42% and recovery of 96.84%, while the MDEA with a slightly higher insol of 5.65% gave a recovery of 96.08%. Of course, these formulations were not optimized for selectivity, however.

Taken all together, these difatty ester quaternary amines demonstrate an ability to provide good performance for the phosphate industry. As such, they represent a new class of cost effective cationic reagent that does not rely on the use of historical polyethylenepolyamines, which are increasingly vanishing from the market place.

1. A process for beneficiating a siliceous mineral ore by froth flotation, comprising treating the siliceous mineral ore with an effective amount of a quaternary esteramine represented by the formula: 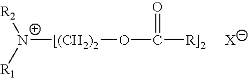
wherein
R is C₁₂-C₂₂ alkyl or alkenyl, or mixtures thereof:
R₁ is C₁-C₄ alkyl or hydroxyethyl;
R₂ is methyl or ethyl substituent; and
X⁻ is a cationic compatible anion.

2. A process according to claim 1 wherein the mineral ore is a phosphate ore.

3. The process according to claim 1 wherein the quaternary esteramine is derived from tall oil fatty acid, tallow, or vegetable fatty acid, or derivatives thereof.

4. A process according to claim 1 wherein the quaternary esteramine is derived from triethanolamine condensates.

5. A process according to claim 1 wherein the quaternary esteramine is derived from N-methyldiethanolamine or N-methyldiethanolamine by-product condensates.

6. A process according to claim 1 wherein the quaternary esteramine is prepared using dimethyl sulfate, diethyl sulfate or methyl chloride.

7. A process according to claim 2 wherein the phosphate ore is a rougher concentrate and the collector is present in a ratio of from about 0.05 to about 1 kilogram of collector per metric ton of rougher float concentrate.

8. A process according to claim 1 wherein the quaternary esteramine is selected from the group consisting of methyl bis[ethyl (tallate)]-2-hydroxyethyl ammonium methyl sulfate; methyl bis[ethyl (tallowate)]-2-hydroxyethyl ammonium methyl sulfate; dimethyl bis[ethyl (tallate)]ammonium methyl sulfate; dimethyl bis[ethyl (tallowate)] ammonium methyl sulfate; methyl bis[ethyl (soyate)]-2-hydroxyethyl ammonium methyl sulfate; and dimethyl bis[ethyl (soyate)]ammonium methyl sulfate.
